(19) United States
(12) Patent Application Publication
(10) Pub. No.: US 2008/0308073 A1
(43) Pub. Date: Dec. 18, 2008

(54) EVAPORATIVE EMISSIONS CANISTER HAVING AN INTEGRAL MEMBRANE

(76) Inventors: Christopher D. Allen, Eastpointe, MI (US); James T. Dumas, Clinton Township, MI (US); Randy C. Foster, Strafford, MO (US); Donald L. Gepper, Commerce Township, MI (US)

Correspondence Address: Joseph V. Tassone, Esq.;DAYCO PRODUCTS, LLC, 1 Prestige Place, Miamisburg, OH, 45342, US

(21) Appl. No.: 11/762,270

(22) Filed: Jun. 13, 2007

(51) Int. Cl. F02M 33/02

(52) U.S. Cl. 123/519

(57) ABSTRACT

An evaporative emissions canister for use in an automotive evaporative emission system to control emission of fuel vapors to the atmosphere. The canister includes an integrally molded housing having a circumferential side member, a top member and a bottom member; a hydrocarbon-adsorbing material disposed therein so as to provide a vapor adsorbent chamber for adsorbing hydrocarbon fuel vapor flowing therethrough; and an internal membrane located above the vapor adsorbent chamber in the fresh air side of the adsorbent chamber for preventing the fuel vapor molecules from passing through the internal membrane while allowing the air molecules to pass therethrough. The internal membrane is characterized as a cellular fibular material having physical properties sufficient to effectively cause any fuel vapor component molecules and associated pollutants to be sufficiently filtered or separated on the membrane while allowing fresh air molecules to pass freely therethrough.

### BACKGROUND OF THE INVENTION

The present invention relates to a fuel system for an internal combustion engine; particularly, to a method and an evaporation emissions system for preventing or reducing the emission of hydrocarbon pollutants into the atmosphere; and most particularly, to an advanced evaporative emissions canister having an integrated membrane which acts as a filter media to prevent or reduce the permeation of hydrocarbon fuel to the atmosphere.

Evaporative emissions result from any one of several events which includes venting of fuel vapors from the fuel tank due to diurnal changes in ambient pressure and/or temperatures (known in the art as “diurnal” emissions or “bleed” emissions), by refueling of the vehicle (known in the art as “refueling” emissions) or by vaporization of fuel by a hot engine and/or exhaust. Generally, the venting of fuel vapor from the fuel tank due to diurnal pressure and/or temperature (diurnal emission), and the escape of fuel vapor during refueling (refueling emissions) are responsible for a majority of the emissions.

Environmental regulations imposed on the automotive industry by the environmental Protection Agency require that automotive vehicles such as gasoline and diesel powered passenger cars and trucks have on board hydrocarbon emissions controls to prevent or limit the amount of hydrocarbon pollutants expelled into the atmosphere. Such hydrocarbon pollutants are a major contributor to smog formations and contribute to the depletion of the ozone layer in our atmosphere. As a result of government mandates, automotive manufacturers are constantly being challenged to find better and more efficient ways to prevent or reduce the emissions of hydrocarbon fuel vapors and other pollutants into the atmosphere. Such emissions can be controlled by canister systems that employ carbon, preferably activated carbon, to adsorb and hold the hydrocarbon vapors. The adsorbed hydrocarbon vapor is periodically desorbed from the carbon by drawing fresh air into the carbon bed to displace the hydrocarbon fuel vapor. The displaced fuel vapor is then passed to the engine where it is consumed. The renewed carbon can then adsorb additional hydrocarbon fuel vapor from the fuel system by withdrawing the air back out through the vent side of the canister.

Currently, fuel systems employed in the automotive industry employ evaporative emissions canister having an inlet port for receiving fuel vapor from the fuel tank where the fuel vapor is adsorbed on an adsorbent material and stored until such time the stored fuel vapor is returned to the fuel tank or, preferably, directed to the engine where it is consumed. Examples of evaporative emissions canisters are described in a number of U.S. Patents and Patent Applications such as U.S. Pat. No. 4,203,401 to Kingsley et al.; U.S. Pat. No. 4,658,796 To Yoshida et al.; 4,683,862 to Fornuto et al.; U.S. Pat. No. 5,119,791 to Gifford, et al.; U.S. Pat. No. 5,408,977 to Cotton; U.S. Pat. No. 5,924,410 to Dumas et al.; U.S. Pat. No. 5,957,114 to Johnson et al; U.S. Pat. No. 6,136,075 to Bragg et al; U.S. Pat. No. 6,237,574 to Jamrog et al.; U.S. Pat. No. 6,540,815 to Hiltzik et al.; and RE38, 844 to Hiltzik et al, and U.S. Pat. Appln. Nos. 2005/0061301 to Meiller; 2005/0123458 to Meiller; and 2006/0065252 to Meiller.

In prior art evaporative emission canisters, the amount of fuel vapor that can be contained in the canister is finite and dependent upon the amount and adsorbent capability characteristics of the adsorbent material contained in the canister. Some prior art canisters employ auxiliary canisters to increase the adsorbent material capacity. The use of additional canisters not only increase the complexity and cost of the evaporative emissions system, but also requires additional space considerations due to the limited space available in the region of the vehicle wherein a canister is installed. Therefore, there is a need in the industry for an evaporative emissions canister which provides increased adsorbent capacity without increasing the complexity, cost and spatial requirements associated with the use of additional canisters and/or filters to achieve the mandated reduction of fuel vapor emissions.

### SUMMARY OF THE INVENTION

It has been found that the emission of hydrocarbon fuel pollutants into the atmosphere during fueling of an automotive vehicle and in the operation of such vehicle, can be substantially reduced or even eliminated by integrally incorporating a membrane into the evaporative emissions canister of the automotive fuel emissions system. The membrane which is characterized as a cellular fibular material having physical properties such as pore size, nominal flow path, membrane area and thickness favorable for the intended use of the membrane. In the present invention, a membrane having the desired physical characteristics for use in an automotive fuel system to satisfy evaporative emissions requirements. In accordance with the invention, a membrane is located at the exit atmospheric port of the adsorption canister of the evaporative emissions system to filter or separate any fuel vapor molecules and prevent such fuel vapor molecules from being emitted into the atmosphere during refueling. The membrane permits air to flow through the membrane pores while trapping fuel vapor molecules. During the canister purge cycle, the fuel vapor molecules are drawn back into the adsorption bed and eventually to the vehicle's engine. The membrane is available from companies such as Amersham Biosciences Membrane Separations Group, W. L. Gore & Associates.

The membrane not only increases the efficiency of the adsorbent material in the evaporative emissions canister, but also restricts nearly all of the hydrocarbon molecules associated with fuel vapor from escaping into the atmosphere, while allowing clean air molecules to pass freely through the membrane.

Accordingly, it is a primary object of this invention to provide an improved evaporative emissions system, which incorporates a membrane directly in the evaporative emissions canister wherein the full capacity of the adsorbent material can be effectively utilized.

It is another object of the invention to provide an evaporative emissions canister that provides reduced fuel emissions to the atmosphere.

It is still another object of the invention to optimize the overall packaging of the evaporative emissions system.

It is another object of the invention to provide an evaporative emissions canister, which eliminates the requirement for an additional canister in the evaporative emissions system between the fuel tank and the canister.

It is yet another object of the invention to provide all of the above objects of the invention without complexity and economic strain.

These objects as well as other objects, features and advantages of the present invention will be apparent to those skilled in the art from the following detailed description, appended claims and accompanying drawings.

### BRIEF DESCRIPTION OF THE DRAWINGS

FIG. 1 is a schematic illustration of an evaporative emission system of a combustion engine in accordance with the present invention;

FIG. 2 is a partially cut-away side view of an evaporative emissions canister of the evaporative emissions systems of FIG. 1, illustrating the membrane positioned in the evaporative emissions canister;

FIG. 3 is a partially cut-away perspective view of the evaporative emissions canister of FIG. 1; and

FIG. 4 is a perspective view of an internal membrane of the present invention.

### DETAILED DESCRIPTION OF THE INVENTION

According to the invention, an evaporative emissions canister, such as that described in commonly assigned U.S. patent application. Ser. No. 11/592,973, filed Nov. 3, 2006, the contents of which are incorporated herein by reference thereto, can be effectively employed to not only reduce the amount of fuel vapor pollutants such as nitrogen oxides, sulfur oxides, etc. into the atmosphere, but to substantially improve the efficiency of the adsorbent material in the evaporative emissions canister by integrally installing a membrane directly in the evaporative emissions canister. The membrane is characterized as a cellular fibular material having physical properties sufficient to effectively cause any fuel vapor component molecules including organic pollutants to be sufficiently filtered or separated by the membrane while allowing fresh air molecules to pass freely therethrough.

In addition to the above-mentioned physical properties necessary for the sufficient separation of fuel vapor molecules from fresh air molecules in the evaporative emissions system, there are other properties that affect mass transfer during gas separation through a membrane. Such additional properties include:
Mobility Selectivity—It retards the movement of one species while allowing the movement of the other species. This is done by controlling the size distribution of the network of available passages (pores) to favor one of the components relative to the rest.
Solubility Selectivity—Selectivity is also determined by the relative sorptivity of the mixture components. Normal boiling point of mixture components is a good indicator of solubility selectivity. The higher the boiling point of a species, the more condensable is the gas and therefore higher is sorptivity.
Transport Plasticization—Due to the presence of a penetrant, the size range of transient gaps tends to be less sharply controlled and therefore mobility selectivity begin to fall. Therefore, interaction between mixture components and membrane material is important.
Operating Temperature—Higher temperature increases molecular diffusivity and less size-discriminating gaps in the polymer matrix. Therefore, permeability increases and selectivity decreases.
   Reference: R. W. Baker, E. L. Cussler, W. Eykamp, W. J. Koros, R. L. Riley and H. Strathmann, Membrane Separation Systems Recent Developments and Future Directions, Chap 3, vol. II, pp. 189-241, Noyes Data Corp, New Jersey, USA, 1991.

The membrane employed in the present invention filters or separates substantially all of the fuel vapor molecules including any pollutants from the vapor to be emitted to the atmosphere while allowing substantially all of the air molecules to pass freely therethrough. Preferably, the membrane filters or separates greater than about 95% of the fuel vapors from the vapor to be emitted to the atmosphere. Accordingly, the membrane effectively prevents or substantially reduces the permeation of fuel vapor molecules and associated pollutants through the membrane while allowing air molecules to pass freely therethrough.

The evaporative emissions canister of the present invention incorporates the membrane on the vent or fresh air side of the evaporative emissions canister at the vent or fresh air inlet/outlet port. By installing the membrane at the vent or fresh air inlet/outlet port, the membrane prevents the permeation of the hydrocarbon fuel vapor through the membrane, thereby allowing the entire adsorbent bed to be utilized for adsorbing fuel vapor as opposed to prior canisters which effectively utilize only a fraction of the adsorbent material contained in the canister for the adsorption of the fuel vapor. A considerable amount of the adsorbent material is used as a buffer on the vent side of the canister. Accordingly, prior devices effectively utilize only about one-half to two-thirds of the capacity of the adsorbent bed. As more fully described below, the evaporative emissions canister of the present invention which utilizes a membrane on the vent or fresh air side of the canister provides a more effective and more efficient device for preventing or reducing the emission of fuel vapor into the atmosphere.

The canister device of the present invention may be of any physical configuration and dimension employed in the art for the prevention or reduction of hydrocarbon emissions into the atmosphere. However, for the purpose of illustration, the automotive evaporative emissions canister comprises:

An automotive evaporative emissions canister for preventing or reducing the emission of residual fuel vapor, from a vent side of said automotive evaporative emissions canister, into the atmosphere, said canister comprising:

a housing including a circumferential side member having an inner surface and

an outer surface, a top member having an inner surface and an outer surface,

and a bottom member having an inner surface and an outer surface;

a first partition extending vertically from said inner surface of said top member, wherein said partition divides said housing into a first compartment and a second compartment;

a first tubular member extending from said housing and in operable communication with said first compartment, the first tubular member providing a passage through which said fuel vapor flows into said first compartment;

a first port in operable communication with said first compartment, said first port providing a passageway through which fuel vapor flows into said first compartment;

a second tubular member extending from said housing and in operable communication with said first compartment providing a passageway through which fuel vapor, desorbed from said fuel adsorbent material, flows from said first compartment to an automotive engine where said fuel vapor is consumed during a purge step;

a second port in operable communication with said housing, said second port providing a passageway through which fuel vapor flows from said evaporative emissions canister to said second tubular member;

a third tubular member extending from said housing, said third tubular member providing a passage through which fresh air is admitted to said second compartment during a purging step, and through which air from an air/fuel mixture is vented to said atmosphere in a venting step; and

a third port in operable communication with said second compartment, said third port providing a passageway through which air is admitted to said second chamber upon desorption of said fuel vapor during a purging stage and for venting said air/fuel vapor through said third port to the atmosphere during a venting stage; and

an internal membrane integrally disposed in said second compartment adjacent said inner surface of said top member and in operable communication with said third port, wherein said membrane prevents or substantially reduces fuel vapor, present in said air vented to the atmosphere through said third port, from escaping into the atmosphere.

As described in the aforementioned copending U.S. patent application Ser. No. 11/592,973, the fuel vapor from the fuel tank may contain a small amount of liquid fuel entrained along with the fuel vapor. If such liquid fuel is allowed to contact the adsorbent material in the evaporative emissions canister, the effectiveness of the adsorbent material may be severely diminished. Therefore, the canister of the aforementioned copending application contains provisions for a liquid-fuel trap to be integrally incorporated into the canister directly above the adsorbent chamber. Such canister would find similar utility in the present application.

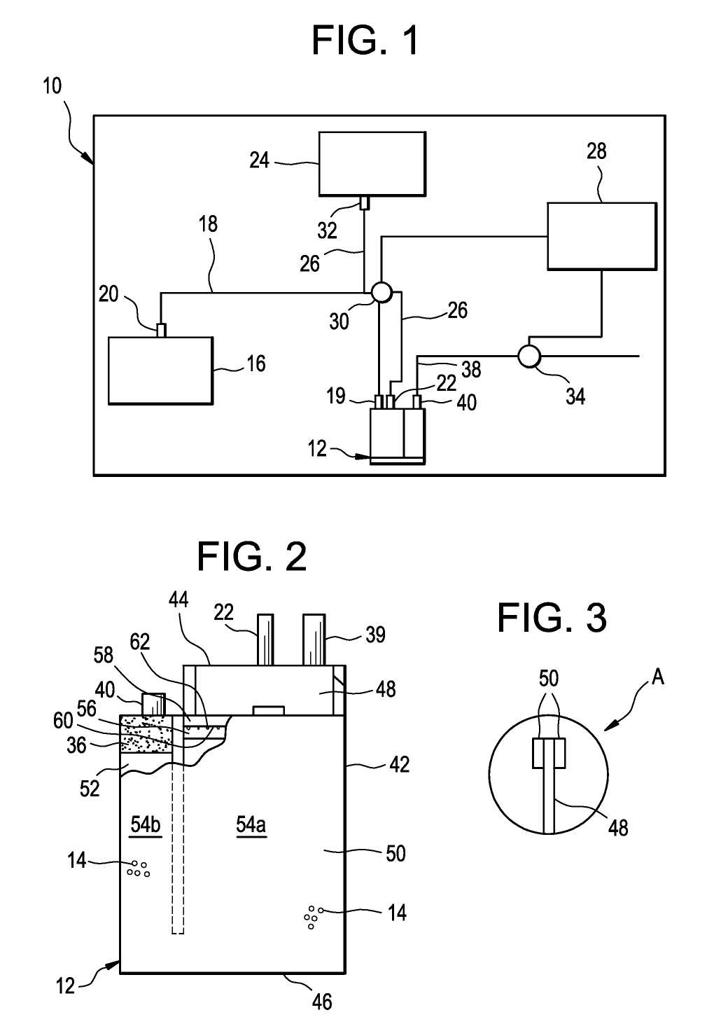

Turning now to the drawings, FIG. 1 is a schematic illustration of an evaporative emissions system for an automotive vehicle (not shown). As illustrated in FIG. 1, the evaporative emissions system 10 includes an evaporative emissions canister 12 containing a bed of adsorbent material 14 (FIGS. 2 and 3). Fuel vapor vented from the fuel tank 16 flows through the fuel vapor line 18 that communicates with fuel tank 16 via port 20 and with canister 12 via port 22. The fuel vapor is vented from the fuel tank 16 where it flows through fuel vapor line 18 to the canister 12, where the fuel vapor is adsorbed on the bed of adsorbent material. The adsorbed fuel vapor is then purged from the adsorbent material via port 19 as necessary by applying engine vacuum on the bed of adsorbent material, drawing fresh air from the atmosphere and through the adsorbent material to displace the fuel vapor. The displaced fuel vapor is then fed to the engine 24 through engine vacuum line 26, and consumed during a purge step.

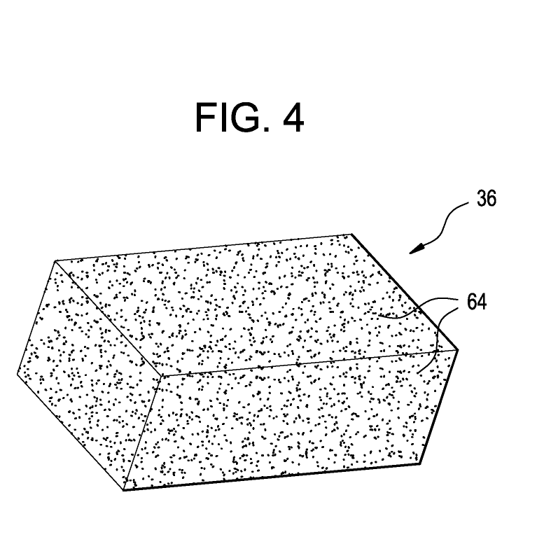

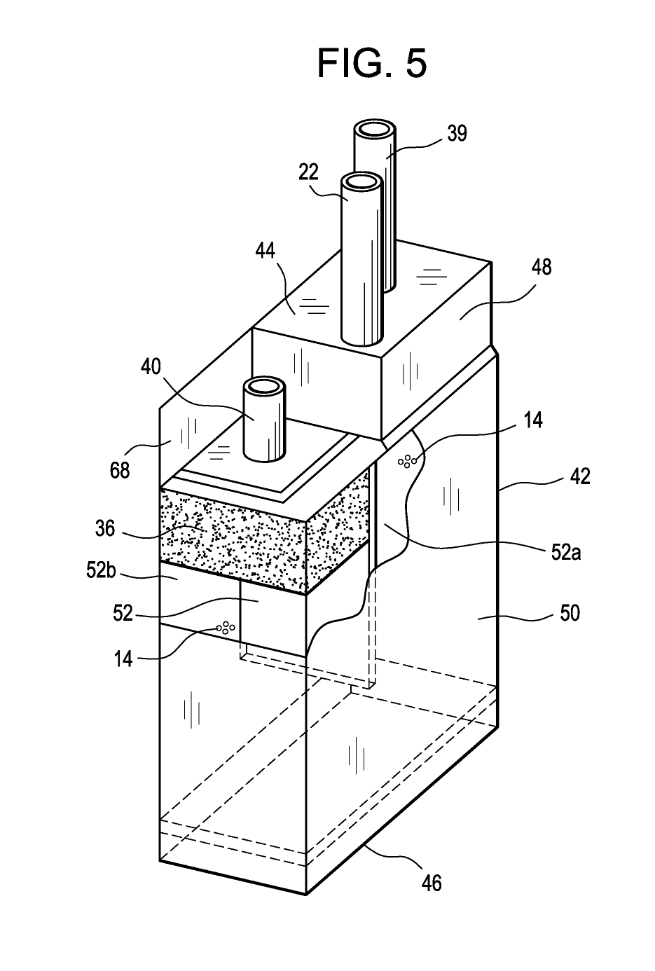

When the adsorbent material becomes saturated with the fuel vapor, engine controller 28 commands fuel vapor valve 30 to close the fuel vapor load line 18 and the fuel vapor is then desorbed from the adsorbent material 14 and drawn by vacuum through an engine vacuum controller 28 connecting engine vacuum line 26 to the engine 24 via port 32 where the desorbed fuel vapor is consumed. A vacuum is created by opening the fresh air valve 34 causing fresh air from the atmosphere to be drawn into the canister 12 through a membrane 36 (FIGS. 2-4) at fresh air line 38 connected to canister 12 via fresh air port 40. Upon removal of the fuel vapor from the adsorbent material 14, the fuel vapor valve 30 is opened so that additional fuel vapor from the fuel tank 16 can be transported via fuel vapor load line 18 to the canister 12 where it is adsorbed on the renewed adsorbent material 14. At the same time the air is forced back through the adsorbent material 14, through the membrane 36 at the fresh air port 40, and through the fresh air line 38 on to the atmosphere. The fresh air valve 34 is opened and closed by the engine controller 28 allowing fresh air to enter the canister 14 during the purging step and to allow fresh air to exit the canister during the adsorption step. However, the fresh air valve 34 typically remains open until routine or diagnostic steps are performed on the automotive vehicle.

As shown in FIGS. 2 and 3, the canister 12 is adapted to be installed in an automotive vehicle by bracket 68. The canister 12 includes a housing having a side member 42, a top member 44 and a bottom member 46. The canister 12 further includes a fuel vapor receiving chamber 48 located above the adsorbent chamber 50. The adsorbent chamber 50 includes a partition 52 that divides the adsorbent chamber into two compartments 54a and 54b. The adsorbent material 14 in the first compartment 54a, which is located directly below the fuel vapor receiving chamber 48, adsorbs and stores the fuel vapor as it enters the compartment 54a. During a purge step, the fuel vapor valve 30 is actuated to draw fresh air from the fresh air valve 34 (FIG.1) through the second compartment 54b via fresh air port 40 where the fresh air travels through the membrane 36 around the bottom of the partition 52 displacing the fuel vapor adsorbed and stored in the adsorbent material 14 residing in the compartment 54a. The displaced fuel vapor proceeds to the automotive engine 24 through engine vacuum line 26, where it is consumed. Fuel vapor entering the canister 12 through port 22 (FIG. 2) is passed into the first compartment 54a of the adsorbent chamber 50, which contains the adsorbent material 14.

In order to keep the adsorbent material 14 inside the adsorbent material chamber 50, a barrier member 56 may be disposed between the fuel vapor-receiving chamber 48 and the adsorbent chamber 50 so that the adsorbent material 14 will not be inadvertently escaping from the adsorbent chamber 50 and entering the fuel vapor-retaining chamber 48. Typically the barrier member 56 is a porous material such as a foamed polymeric material, a fibrous material, or the like. Also a relatively rigid support member 58 having one or more apertures 66 therein to allow the fuel vapor to flow therethrough may be disposed between the fuel vapor receiving chamber 48 and the first compartment 54a to allow the fuel vapor to flow therebetween. The bottom surface 60 of the support member 58 preferably includes a plurality of finger elements 62 extending downwardly from the bottom surface 60 of the barrier member 58. The finger elements 62 interconnect with the barrier member 58 to provide the barrier member 58 with a relatively flat surface having increased surface area.

The evaporative emissions canister of the present invention is manufactured from any material possessing the desirable properties and characteristics, such as flexibility, fuel resistance, heat resistance, pressure resistance, weatherability, dimensional stability, and high impact strength. Typically, such material is a polymeric material, preferably, a polyamide such as nylon 6 or nylon 6/6, or a polyolefin such as polypropylene.

Typically, the evaporative emissions canister, including the various parts thereof, is molded in one piece to provide a continuous unitary structure thereby reducing the need for assembly steps.

The adsorbent material useful in the invention may be any of the conventional materials effective to adsorb hydrocarbon materials such as fuel vapor. Preferable, the adsorbent material is carbon and most preferably activated carbon. The carbon can be in any desired form having an effective particle size sufficient to maximize the adsorbance of the fuel vapor in the canister.

A barrier member may be installed at the lower end of compartment between the membrane and the adsorbent material to support the membrane.

Typically, the evaporative emissions canister will include a volume compensator, as is well known in the art, located at the bottom of the canister housing to limit shifting of the adsorbent material during operation of the automotive vehicle.

While the present invention has been fully illustrated and described in detail, other designs, modifications and improvements will become apparent to those skilled in the art. Such designs, modifications and improvements are considered to be within the spirit of the present invention, the scope of which is determined only by the scope of the appended claims.

What is claimed is:

1. An automotive evaporative emissions canister for preventing or reducing the emission of residual fuel vapor, from a vent side of said automotive evaporative emissions canister, into the atmosphere, said canister comprising:
a housing including a circumferential side member having an inner surface and an outer surface, a top member having an inner surface and an outer surface, and a bottom member having an inner surface and an outer surface;
a first partition extending vertically from said inner surface of said top member, wherein said partition divides said housing into a first compartment and a second compartment;
a first tubular member extending from said housing and in operable communication with said first compartment, the first tubular member providing a passage through which said fuel vapor flows into said first compartment;
a first port in operable communication with said first compartment, said first port providing a passageway through which fuel vapor flows into said first compartment;
a second tubular member extending from said housing and in operable communication with said first compartment providing a passageway through which fuel vapor, desorbed from said fuel adsorbent material, flows from said first compartment to an automotive engine where said fuel vapor is consumed during a purge step;
a second port in operable communication with said housing, said second port providing a passageway through which fuel vapor flows from said evaporative emissions canister to said second tubular member;
a third tubular member extending from said housing, said third tubular member providing a passage through which fresh air is admitted to said second compartment during a purging step, and through which air from an air/fuel mixture is vented to said atmosphere in a venting step; and
a third port in operable communication with said second compartment, said third port providing a passageway through which air is admitted to said second chamber upon desorption of said fuel vapor during a purging stage and for venting said air/fuel vapor through said third port to the atmosphere during a venting stage; and
an internal membrane integrally disposed in said second compartment adjacent said inner surface of said top member and in operable communication with said third port, wherein said membrane prevents or substantially reduces fuel vapor, present in said air vented to the atmosphere through said third port, from escaping into the atmosphere.

2. The canister of claim 1 wherein said internal membrane is characterized as a cellular fibrous or polymeric material having physical properties sufficient to effectively cause any residual fuel vapor molecules to be sufficiently filtered or separated on said membrane while allowing fresh air molecules to pass freely therethrough.

3. The canister of claim 2 wherein said membrane filters or separates greater than about 95% of the fuel vapor molecules including pollutants from the vapor to be emitted to the atmosphere while allowing substantially all of the air molecules to pass freely therethrough.

4. The canister of claim 1 wherein said housing is a unitary structure molded from a material exhibiting sufficient flexibility, fuel resistance, heat resistance, pressure resistance, weatherability, dimensional stability, and high impact strength to withstand a harsh environment associated with an automotive evaporative emissions system.

5. The canister of claim 4 wherein said housing is molded from a polyamide or a polyolefin.

6. The canister of claim 5 wherein said housing is molded from nylon.

7. The canister of claim 1 wherein said fuel vapor-adsorbent material comprises carbon.

8. The canister of claim 7 wherein said carbon is activated carbon.

9. The canister of claim 1 further comprising a second partition separating said first compartment into a first cavity for receiving said fuel vapor from said fuel tank and a second cavity containing said fuel vapor adsorbent material.

10. The canister of claim 9 further comprising a liquid-fuel vapor trap disposed in said first cavity for trapping and storing liquid fuel entrained along with said fuel vapor from said fuel tank

11. In an automotive evaporative emission system comprising:
a housing including a circumferential side member having an inner surface and an outer surface, a top member having an inner surface and an outer surface, and a bottom member having an inner surface and an outer surface;
a first partition extending vertically from said inner surface of said top member, wherein said partition divides said housing into a first compartment and a second compartment;
a first tubular member extending from said housing and in operable communication with said first compartment, the first tubular member providing a passage through which said fuel vapor flows into said first compartment;
a first port in operable communication with said first compartment, said first port providing a passageway through which fuel vapor flows into said first compartment;
a second tubular member extending from said housing and in operable communication with said first compartment providing a passageway through which fuel vapor, desorbed from said fuel adsorbent material, flows from said first compartment to an automotive engine where said fuel vapor is consumed during a purge step;
a second port in operable communication with said housing, said second port providing a passageway through which fuel vapor flows from said evaporative emissions canister to said second tubular member;
a third tubular member extending from said housing, said third tubular member providing a passage through which fresh air is admitted to said second compartment during a purging step, and through which air from an air/fuel mixture is vented to said atmosphere in a venting step; and
a third port in operable communication with said second compartment, said third port providing a passageway through which air is admitted to said second chamber upon desorption of said fuel vapor during a purging stage and for venting said air/fuel vapor through said third port to the atmosphere during a venting stage including a fuel tank coupled to an automotive engine wherein the evaporative emissions system includes an evaporative emissions canister having a fuel adsorbent compartment containing a fuel adsorbent material to control emission of fuel vapors to the atmosphere, the improvement wherein said evaporative emissions canister comprises a unitary housing having a fuel adsorbent compartment containing a fuel adsorbent material, wherein said fuel adsorbent chamber is divided into a first compartment containing fuel adsorbent material and a second compartment containing an internal membrane through which air enters said second compartment during a purge stage and air exits during a fuel adsorbing stage, wherein said internal membrane is effective to prevent fuel vapor molecules from passing through said membrane by filtering or separating said fuel vapor molecules and pollutants on said membrane while allowing air molecules to pass therethrough.

12. The system of claim 11 wherein said internal membrane is characterized as a cellular fibular material having physical properties sufficient to effectively cause any fuel vapor component molecules or pollutants to be sufficiently filtered or separated on the membrane while allowing fresh air molecules to pass freely therethrough.

13. The system of claim 12 wherein said membrane filters or separates substantially all of the fuel vapor molecules including pollutants from the vapor to be emitted to the atmosphere while allowing substantially all of the air molecules to pass freely therethrough.

14. The system of claim 12 wherein said membrane filters or separates greater than about 95% of the fuel vapor molecules including pollutants from the vapor to be emitted to the atmosphere while allowing substantially all of the air molecules to pass freely therethrough.

15. The system of claim 11 wherein said housing further comprising a liquid-fuel vapor trap disposed therein for trapping and storing liquid fuel entrained along with said fuel vapor from said fuel tank.

16. A method for preventing or reducing emission of fuel by-products from an automotive vehicle into the atmosphere, said method comprising:
(1) Providing an evaporative emissions canister between a fuel tank and an internal combustion engine, wherein said evaporative emissions canister comprises:
(a) a housing having a circumferential side member having an inner surface and an outer surface, a top member having an inner surface and an outer surface and a bottom member having an inner surface and an outer surface, wherein said inner surface of said circumferential side member, said inner surface of said top member and said inner surface of said bottom member form a chamber for receiving fuel vapor from a fuel tank containing a fuel vapor-adsorbent material for adsorbing said fuel vapor from said fuel tank;
(b) a partition extending vertically from said inner surface of said top member, wherein said partition divides said chamber into a first compartment having said fuel adsorbent disposed therein for adsorbing said fuel vapor from said fuel tank and a second compartment for expelling air to the atmosphere during a venting step and for receiving fresh air during a purge step;
(c) a first port in said housing and in operable communication with said first chamber, said first port providing a passageway through which fuel vapor flows into said first chamber;
(d) a first tubular member operatively connected to said first port through which fuel vapor flows into said first chamber;
(e) a second port in said housing and in operable communication with said second chamber, said second port providing a passageway through which fuel vapor flows from said evaporative emissions canister to an automotive engine where said fuel vapor is consumed;
(f) a second tubular member operatively connected to said second port through which fuel vapor flows from said evaporative emissions canister to an automotive engine where said fuel vapor is consumed during a purge step;
(g) a third port extending in said housing and in operable communication with said second compartment, said third port providing a passageway through which air is admitted to said second compartment upon desorption of said fuel vapor during a purging stage and for venting said air to the atmosphere during a venting stage; and
(h) a second tubular member operatively connected to said second port through which fuel vapor flows from said evaporative emissions canister to an automotive engine where said fuel vapor is consumed during a purge step; and
(2) providing a membrane, wherein said membrane prevents or substantially reduces fuel vapor from escaping into the atmosphere through said third port, and
(3) integrally installing said membrane in said second compartment of said evaporative emissions canister adjacent said inner surface of said top member and in operable communication with said third port wherein said membrane, sequentially, provides free flow of fresh air from the atmosphere to the evaporative emissions canister during a purge step wherein fuel vapor is desorbed from said adsorbent material in said evaporative emissions canister, and providing a free flow of a air/residual fuel vapor mixture from said evaporative emissions canister to the atmosphere in a vent step, said membrane separating said residual fuel vapor from said air/fuel vapor mixture and returning said fuel vapor to said evaporative emissions canister.

17. The method of claim 16 wherein said membrane is characterized as a cellular fibular material having physical properties sufficient to effectively cause any fuel vapor component molecules to be sufficiently filtered or separated on said membrane while allowing fresh air molecules to pass freely therethrough.

18. The method of claim 17 wherein said membrane filters or separates substantially all of the fuel vapor molecules including pollutants from the vapor to be emitted to the atmosphere while allowing substantially all of the air molecules to pass freely therethrough.

19. The method of claim 17 wherein said membrane filters or separates greater than about 95% of the fuel vapor molecules including pollutants from the vapor to be emitted to the atmosphere while allowing substantially all of the air molecules to pass freely.

20. The method of claim 16 further comprising a liquid-fuel vapor trap disposed therein for trapping and storing liquid fuel entrained along with said fuel vapor from said fuel tank.
